(19) United States
(12) Patent Application Publication
(10) Pub. No.: US 2019/0151944 A1
(43) Pub. Date: May 23, 2019

(54) Additive Manufacturing with a Two-Part Polygon Scanner

(71) Applicant: Applied Materials, Inc., Santa Clara, CA (US)

(72) Inventors: Paul J. Steffas, Santa Clara, CA (US); Ajey M. Joshi, San Jose, CA (US); Jeffrey L. Franklin, Santa Cruz, CA (US); Zhihong Lin, Sunnyvale, CA (US)

(21) Appl. No.: 16/169,988

(22) Filed: Oct. 24, 2018

Related U.S. Application Data
(60) Provisional application No. 62/590,211, filed on Nov. 22, 2017.

(51) Int. Cl. B22F 3/105; B23K 26/06; B23K 26/073; B23K 26/082; B23K 26/08; B29C 64/153; B29C 64/20

(52) U.S. Cl. CPC B22F 3/1055; B23K 26/0604; B23K 26/0626; B29C 64/20; B23K 26/082; B23K 26/0869; B29C 64/153; B23K 26/073

(57) ABSTRACT

An additive manufacturing apparatus includes a platform, a dispenser to deliver a plurality of successive layers of feed material onto the platform, a light source to generate a light beam, a first polygon mirror scanner to reflect the light beam towards the platform, and a second polygon mirror scanner to reflect the light beam towards the platform. The light beam is alternately directed to the first polygon mirror scanner and the second polygon mirror scanner such that the light beam is directed to the first polygon mirror scanner during a dead time of the second polygon mirror scanner and the light beam is directed to the second polygon mirror scanner during a dead time of the first polygon mirror scanner.

### CROSS-REFERENCE TO RELATED APPLICATIONS

This application claims priority to U.S. Application Ser. No. 62/590,211, filed on Nov. 22, 2017, the entire disclosure of which is incorporated by reference.

### TECHNICAL FIELD

This disclosure relates to an energy delivery system for additive manufacturing, also known as 3D printing.

### BACKGROUND

Additive manufacturing (AM), also known as solid freeform fabrication or 3D printing, refers to a manufacturing process where three-dimensional objects are built up from successive dispensing of raw material (e.g., powders, liquids, suspensions, or molten solids) into two-dimensional layers. In contrast, traditional machining techniques involve subtractive processes in which objects are cut out from a stock material (e.g., a block of wood, plastic, composite, or metal).

A variety of additive processes can be used in additive manufacturing. Some methods melt or soften material to produce layers, e.g., selective laser melting (SLM) or direct metal laser sintering (DMLS), selective laser sintering (SLS), or fused deposition modeling (FDM), while others cure liquid materials using different technologies, e.g., stereolithography (SLA). These processes can differ in the way layers are formed to create the finished objects and in the materials that are compatible for use in the processes.

In some forms of additive manufacturing, a powder is placed on a platform and a laser beam traces a pattern onto the powder to fuse the powder together to form a shape. Once the shape is formed, the platform is lowered and a new layer of powder is added. The process is repeated until a part is fully formed.

### SUMMARY

This disclosure describes technologies relating to additive manufacturing with a polygon scanner.

In one aspect, an additive manufacturing apparatus includes a platform, a dispenser configured to deliver a plurality of successive layers of feed material onto the platform, a light source configured to generate a light beam, a first polygon mirror scanner configured to receive the light beam from the light source and reflect the light beam towards the platform, and a second polygon mirror scanner configured to receive the light beam from the light source and reflect the light beam towards the platform. The first polygon mirror and the second polygon mirror scanner share a common axis of rotation.

In another aspect, an additive manufacturing apparatus includes a platform, a dispenser configured to deliver a plurality of successive layers of feed material onto the platform, a light source configured to generate a light beam, a first polygon mirror scanner configured to receive the light beam from the light source and reflect the light beam towards the platform, and a second polygon mirror scanner configured to receive the light beam from the light source and reflect the light beam towards the platform. The first polygon mirror and the second polygon mirror scanner configured to reflect the light beam towards a same scan path on an outermost layer of feed material. The light source is configured to alternately direct the light beam to the first polygon mirror scanner and the second polygon mirror scanner.

Implementations of any aspect may include one or more of the following features.

An axis of rotation of the first polygon mirror may be parallel to an axis of rotation of the second polygon mirror scanner. The first polygon mirror and the second polygon mirror scanner may have a common axis of rotation. The second polygon mirror may be adjacent the first polygon mirror. The second polygon mirror may abut the first polygon mirror. The first polygon mirror scanner and the second polygon mirror scanner may be configured to rotate in unison with one another. The first polygon mirror scanner and the second polygon mirror scanner may have a common axle and a common motor to drive the axle.

The first polygon mirror scanner and the second polygon mirror scanner may have an equal number of sides. The first polygon mirror scanner and the second polygon mirror scanner may be angularly offset from one another so that an edge of the first polygon mirror scanner is positioned at an approximate center of a face of the second polygon mirror scanner.

A steering mirror may be configured to direct the light beam from the light source alternately to the first polygon mirror scanner and the second polygon mirror scanner.

The first polygon mirror scanner and the second polygon mirror scanner are may be configured to reflect the light beam towards a same scan path. The scan path may be perpendicular to the axis of rotation of the first polygon mirror scanner and the axis of rotation of the second polygon mirror scanner.

The first polygon mirror scanner may have a first plurality of facets with a first inclination relative to the common axis of rotation, and the second polygon mirror scanner may have a second plurality of facets with a different second inclination relative to the common axis of rotation. The first inclination may be equal magnitude and opposite direction to the second inclination.

The first polygon mirror scanner and the second polygon mirror scanner may be configured to rotate in in opposite directions to one another.

A controller may be configured to, where a continuous line is to be generated across the layer of feed material, cause the light source to generate a light beam more for than 50% of a rotational period of the first polygon scanner mirror. The controller may be configured to turn off the light beam during transition between first polygon mirror scanner and the second polygon mirror.

In another aspect, an additive manufacturing method includes producing a light beam with a light source, directing a light beam to a first polygon mirror scanner, scanning the light beam across a scan path across a top layer of a feed material on a platform with the first polygon mirror scanner, directing a light beam to a second polygon mirror scanner, and scanning the light beam across the scan path across a top layer of a feed material on a platform with the second polygon mirror scanner.

Directing the light beam to the first polygon mirror scanner may include reflecting the light beam off of a single-axis mirror scanner. Directing a light beam to the second polygon mirror scanner may include reflecting the light beam off of a single-axis mirror scanner.

The first polygon mirror scanner and the second polygon mirror scanner may be rotated about a same axis, at a same speed, and in a same direction of rotation. The first polygon mirror scanner and the second polygon mirror scanner may be rotated about a same axis, at a same speed, and in an opposite direction of rotation.

Particular implementations of the subject matter described in this disclosure can be implemented so as to realize one or more of the following advantages. Lower energy is consumed to fabricate a given part. Parts can be fabricated faster. Because the dead time has been significantly reduced or eliminated between scans, residual heat energy from the previous scan is preserved and can be used to increase the laser speed. This will bring the efficiency up from 50% laser use to near 100%. Part fabrication time may be decreased as much as 50%.

The details of one or more implementations are set forth in the accompanying drawings and the description. Other features, aspects, and advantages of the subject matter will become apparent from the description, the drawings, and the claims.

### BRIEF DESCRIPTION OF THE DRAWINGS

FIGS. 1A-1B are schematic diagrams including side and top views, respectively, of an example additive manufacturing apparatus.

FIGS. 2A is a schematic side-view diagrams of a of an example mirror scanner system.

FIGS. 2B and 2C are schematic front-view diagrams of an example mirror scanner system.

FIG. 3 is a flowchart of an example method that can be utilized with aspects of this disclosure.

Like reference numbers and designations in the various drawings indicate like elements.

### DETAILED DESCRIPTION

In many additive manufacturing processes, energy is selectively delivered to a layer of feed material dispensed by an additive manufacturing apparatus to fuse the feed material in a pattern, thereby forming a portion of an object. For example, a light beam, e.g., a laser beam, can be reflected off a rotating polygon scanner to drive the light beam in a linear path across the layer of feed material. Relative motion between the light source and the support or a secondary mirror can be used to cause the light beam to perform a raster-scan the layer.

In addition, in order to avoid reflection of the laser beam in unexpected or undesired directions, the light beam can be turned off during times corresponding to the transition between facets on the polygon, e.g., during times that any portion of the light beam would fall on an edge between facets. As a result, the light is turned on only while the light beam would impinge some central portion along the length of the facet. For example, when a laser and polygon mirror are used to scan and fuse a layer of feed material, some percentage, typically 50%, of the time needed for a rotation of the polygon is “dead time.” This is because only the center 50% of the mirrored facet is typically used to reflect the laser onto the metal powder bed, so the laser is only turned on for 50% of each facet. This inherent inefficiency of the polygon may be one of the reasons that galvo laser directed scanning has been historically preferred over the polygon method.

This disclosure describes an improved polygon mirror scanner that includes two polygons, each with the same number of facets, placed next to each other but phase shifted by ½ facet. A steering mirror can be used to direct the light beam back and forth between the polygons using a facet on one polygon, while the other is in dead time and vice versa. Such a set-up allows the light beam, e.g., the laser, to remain on up to nearly 100% of the time.

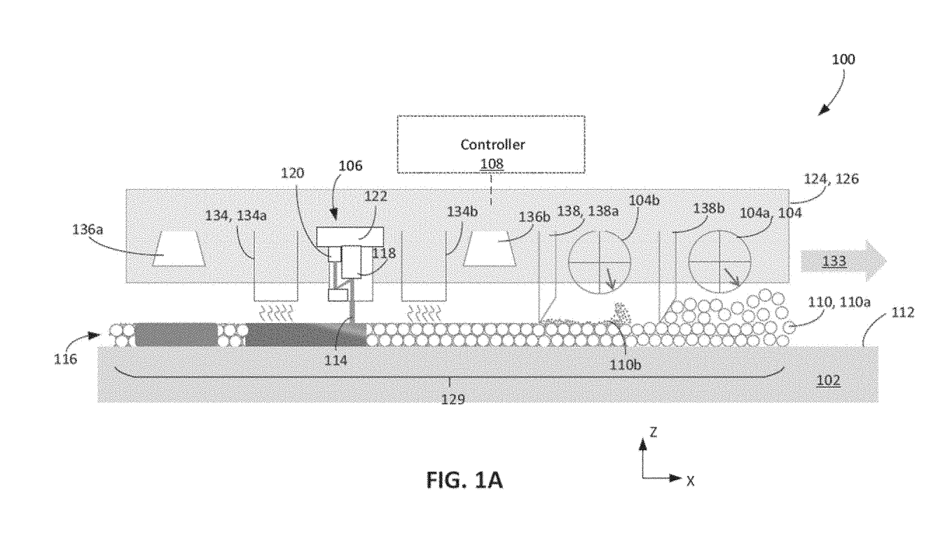

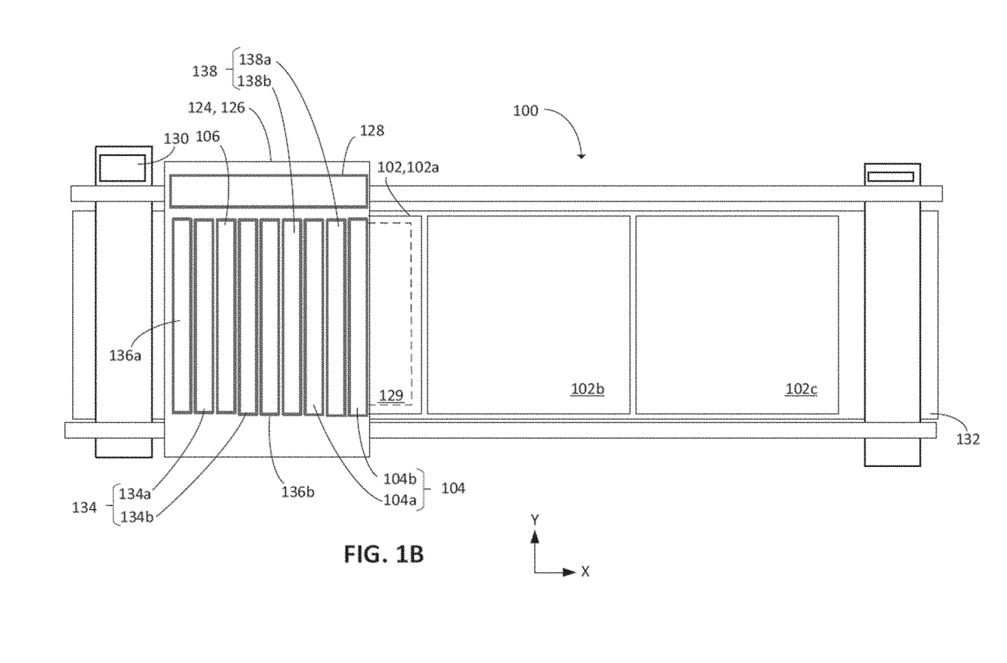

Referring to FIGS. 1A and 1B, an example of an additive manufacturing apparatus 100 includes a platform 102, a dispenser 104, an energy delivery system 106, and a controller 108. During an operation to form an object, the dispenser 104 dispenses successive layers of feed material 110 on a top surface 112 of the platform 102. The energy delivery system 106 emits a light beam 114 to deliver energy to an uppermost layer 116 of the layers of feed material 110, thereby causing the feed material 110 to be fused, for example, in a desired pattern to form the object. The controller 108 operates the dispenser 104 and the energy delivery system 106 to control dispensing of the feed material 110 and to control delivery of the energy to the layers of feed material 110. The successive delivery of feed material and fusing of feed material in each of the successively delivered layers result in formation of the object.

The dispenser 104 can be mounted on a support 124 such that the dispenser 104 moves with the support 124 and the other components, e.g., the energy delivery system 106, that are mounted on the support 124.

The dispenser 104 can include a flat blade or paddle to push a feed material from a feed material reservoir across the platform 102. In such an implementation, the feed material reservoir can also include a feed platform positioned adjacent the build platform 102. The feed platform can be elevated to raise some feed material above the level of the build platform 102, and the blade can push the feed material from the feed platform onto the build platform 102.

Alternatively, or in addition, the dispenser can be suspended above the platform 192 and have one or more apertures or nozzles through which the powder flows. For example, the powder could flow under gravity, or be ejected, e.g., by a piezoelectric actuator. Control of dispensing of individual apertures or nozzles could be provided by pneumatic valves, microelectromechanical systems (MEMS) valves, solenoid valves, and/or magnetic valves. Other systems that can be used to dispense powder include a roller having apertures, and an augur inside a tube having one or more apertures.

As shown in FIG. 1B, the dispenser 104 can extend, e.g., along the Y-axis, such that the feed material is dispensed along a line, e.g., along the Y-axis, that is perpendicular to the direction of motion of the support 124, e.g., perpendicular to the X-axis. Thus, as the support 124 advances, feed material can be delivered across the entire platform 102.

The feed material 110 can include metallic particles. Examples of metallic particles include metals, alloys, and intermetallic alloys. Examples of materials for the metallic particles include aluminum, titanium, stainless steel, nickel, cobalt, chromium, vanadium, and various alloys or intermetallic alloys of these metals.

The feed material 110 can include ceramic particles. Examples of ceramic materials include metal oxide, such as ceria, alumina, silica, aluminum nitride, silicon nitride, silicon carbide, or a combination of these materials, such as an aluminum alloy powder.

The feed material can be dry powders or powders in liquid suspension, or a slurry suspension of a material. For example, for a dispenser that uses a piezoelectric printhead, the feed material would typically be particles in a liquid suspension. For example, a dispenser could deliver the powder in a carrier fluid, e.g. a high vapor pressure carrier, e.g., Isopropyl Alcohol (IPA), ethanol, or N-Methyl-2-pyrrolidone (NMP), to form the layers of powder material. The carrier fluid can evaporate prior to the sintering step for the layer. Alternatively, a dry dispensing mechanism, e.g., an array of nozzles assisted by ultrasonic agitation and pressurized inert gas, can be employed to dispense the first particles.

The energy delivery system 106 includes a light source 120 to emit a light beam 114. The energy delivery system 106 further includes a reflector assembly 118 that redirects the light beam 114 toward the uppermost layer 116. Example implementations of the energy delivery system 106 are described in greater detail later within this disclosure. The reflector assembly 118 is able to sweep the light beam 114 along a path, e.g., a linear path, on the uppermost layer 116. The linear path can be parallel to the line of feed material delivered by the dispenser, e.g., along the Y-axis. In conjunction with relative motion of the energy delivery system 106 and the platform 102, or deflection of the light beam 114 by another reflector, e.g., a galvo-driven mirror or another directing mechanism, a sequence of sweeps along the path by the light beam 114 can create a raster scan of the light beam 114 across the uppermost layer 116.

As the light beam 114 sweeps along the path, the light beam 114 is modulated, e.g., by causing the light source 120 to turn the light beam 114 on and off, in order to deliver energy to selected regions of the layers of feed material 110 and fuse the material in the selected regions to form the object in accordance to a desired pattern.

In some implementations, the light source 120 includes a laser configured to emit the light beam 114 toward the reflector assembly 118. The reflector assembly 118 is positioned in a path of the light beam 114 emitted by the light source 120 such that a reflective surface of the reflector assembly 118 receives the light beam 114. The reflector assembly 118 then redirects the light beam 114 toward the top surface of the platform 102 to deliver energy to an uppermost layer 116 of the layers of feed material 110 to fuse the feed material 110. For example, the reflective surface of the reflector assembly 118 reflects the light beam 114 to redirect the light beam 114 toward the platform 102.

In some implementations, the energy delivery system 106 is mounted to a support 122 that supports the energy delivery system 106 above the platform 102. In some cases, the support 122 (and the energy delivery system 106 mounted on the support 122) is rotatable relative to the platform 102. In some implementations, the support 122 is mounted to another support 124 arranged above the platform 102. The support 124 can be a gantry supported on opposite ends (e.g., on both sides of the platform 102 as shown in FIG. 1B) or a cantilever assembly (e.g., supported on just one side of the platform 102). The support 124 holds the energy delivery system 106 and dispensing system 104 of the additive manufacturing apparatus 100 above the platform 102.

In some cases, the support 122 is rotatably mounted on the support 124. The reflector assembly 118 is rotated when the support 122 is rotated, e.g., relative to the support 124, thus reorienting the path of the light beam 114 on the uppermost layer 116. For example, the energy delivery system 106 can be rotatable about an axis extending vertically away from the platform 102, e.g., an axis parallel to the Z-axis, between the Z-axis and the X-axis, and/or between the Z-axis and the Y-axis. Such rotation can change the azimuthal direction of the path of the light beam 114 along the X-Y plane, i.e., across the uppermost layer 116 of feed material.

In some implementations, the support 124 is vertically movable, e.g., along the Z-axis, in order to control the distance between the energy delivery system 106 and dispensing system 104 and the platform 102. In particular, after dispensing of each layer, the support 124 can be vertically incremented by the thickness of the layer deposited, so as to maintain a consistent height from layer-to-layer. The apparatus 100 further can include an actuator 130 configured to drive the support 124 along the Z-axis, e.g., by raising and lowering horizontal support rails to which the support 124 is mounted.

Various components, e.g., the dispenser 104 and energy delivery system 106, can be combined in a modular unit, a printhead 126, that can be installed or removed as a unit from the support 124. In addition, in some implementations the support 124 can hold multiple identical printheads, e.g., in order to provide modular increase of the scan area to accommodate larger parts to be fabricated.

Each printhead 126 is arranged above the platform 102 and is repositionable along one or more horizontal directions relative to the platform 102. The various systems mounted to the printhead 126 can be modular systems whose horizontal position above the platform 102 is controlled by a horizontal position of the printhead 126 relative to the platform 102. For example, the printhead 126 can be mounted to the support 124, and the support 124 can be movable to reposition the printhead 126.

In some implementations, an actuator system 128 includes one or more actuators engaged to the systems mounted to the printhead 126. For movement along the X-axis, in some cases, the actuator 128 is configured to drive the printhead 126 and the support 124 in their entireties relative to the platform 102 along the X-axis. For example, the actuator can include rotatable gear than engages a geared surface on a horizontal support rail. Alternatively, or additionally, the apparatus 100 includes a conveyor on which the platform 102 is located. The conveyor is driven to move the platform 102 along the X-axis relative to the printhead 126.

The actuator 128 and/or the conveyor causes relative motion between the platform 102 and the support 124 such that the support 124 advances in a forward direction 133 relative to the platform 102. The dispenser 104 can be positioned along the support 124 ahead of the energy delivery system 106 so that feed material 110 can be first dispensed, and the recently dispensed feed material can then be cured by energy delivered by the energy delivery system 106 as the support 124 is advanced relative to the platform 102.

In some implementations, the printhead(s) 126 and the constituent systems do not span the operating width of the platform 102. In this case, the actuator system 128 can be operable to drive the system across the support 124 such that the printhead 126 and each of the systems mounted to the printhead 126 are movable along the Y-axis. In some implementations (shown in FIG. 1B), the printhead(s) 126 and the constituent systems span the operating width of the platform 102, and motion along the Y-axis is not necessary.

In some cases, the platform 102 is one of multiple platforms 102a, 102b, and 102c. Relative motion of the support 124 and the platforms 102a-102c enables the systems of the printhead 126 to be repositioned above any of the platforms 102a-102c, thereby allowing feed material to be dispensed and fused on each of the platforms, 102a, 102b, and 102c, to form multiple objects. The platforms 102a-102c can be arranged along the direction of forward direction 133.

In some implementations, the additive manufacturing apparatus 100 includes a bulk energy delivery system 134. For example, in contrast to delivery of energy by the energy delivery system 106 along a path on the uppermost layer 116 of feed material, the bulk energy delivery system 134 delivers energy to a predefined area of the uppermost layer 116. The bulk energy delivery system 134 can include one or more heating lamps, e.g., an array of heating lamps, that when activated, deliver the energy to the predefined area within the uppermost layer 116 of feed material 110.

The bulk energy delivery system 134 is arranged ahead of or behind the energy delivery system 106, e.g., relative to the forward direction 133. The bulk energy delivery system 134 can be arranged ahead of the energy delivery system 106, for example, to deliver energy immediately after the feed material 110 is dispensed by the dispenser 104. This initial delivery of energy by the bulk energy delivery system 134 can stabilize the feed material 110 prior to delivery of energy by the energy delivery system 106 to fuse the feed material 110 to form the object. The energy delivered by the bulk energy delivery system can be sufficient to raise the temperature of the feed material above an initial temperature when dispensed, to an elevated temperature that is still lower than the temperature at which the feed material melts or fuses. The elevated temperature can be below a temperature at which the powder becomes tacky, above a temperature at which the powder becomes tacky, but below a temperature at which the powder becomes caked, or above a temperature at which the powder becomes caked.

Alternatively, the bulk energy delivery system 134 can be arranged behind the energy delivery system 106, for example, to deliver energy immediately after the energy delivery system 106 delivers energy to the feed material 110. This subsequent delivery of energy by the bulk energy delivery system 134 can control the cool-down temperature profile of the feed material, thus providing improved uniformity of curing. In some cases, the bulk energy delivery system 134 is a first of multiple bulk energy delivery systems 134a, 134b, with the bulk energy delivery system 134a being arranged behind the energy delivery system 106 and the bulk energy delivery system 134b being arranged ahead of the energy delivery system 106.

Optionally, the apparatus 100 includes a first sensing system 136a and/or a second sensing system 136b to detect properties, e.g., temperature, density, and material, of the layer 116, as well as powder dispensed by the dispenser 104. The controller 108 can coordinate the operations of the energy delivery system 106, the dispenser 104, and, if present, any other systems of the apparatus 100. In some cases, the controller 108 can receive user input signal on a user interface of the apparatus or sensing signals from the sensing systems 136a, 136b of the apparatus 100, and control the energy delivery system 106 and the dispenser 104 based on these signals.

Optionally, the apparatus 100 can also include a spreader 138, e.g., a roller or blade, that cooperates with the first dispenser 104 to compact and/or spread feed material 110 dispensed by the dispenser 104. The spreader 138 can provide the layer with a substantially uniform thickness. In some cases, the spreader 138 can press on the layer of feed material 110 to compact the feed material 110. The spreader 138 can be supported by the support 124, e.g., on the printhead 126, or can be supported separately from the printhead 126.

In some implementations, the dispenser 104 includes multiple dispensers 104a, 104b, and the feed material 110 includes multiple types of feed material 110a, 110b. A first dispenser 104a dispenses the first feed material 110a, while a second dispenser 104b dispenses the second feed material 110b. If present, the second dispenser 104b enables delivery of a second feed material 110b having properties that differ from those of the first feed material 110a. For example, the first feed material 110a and the second feed material 110b can differ in material composition or average particle size.

In some implementations, the particles of the first feed material 110a can have a larger mean diameter than the particles of the second feed material 110b, e.g., by a factor of two or more. When the second feed material 110b is dispensed on a layer of the first feed material 110a, the second feed material 110b infiltrates the layer of first feed material 110a to fill voids between particles of the first feed material 110a. The second feed material 110b, having a smaller particle size than the first feed material 110a, can achieve a higher resolution.

In some cases, the spreader 138 includes multiple spreaders 138a, 138b, with the first spreader 138a being operable with the first dispenser 104a to spread and compact the first feed material 110a, the second spreader 138b being operable with the second dispenser 104b to spread and compact the second feed material 110b.

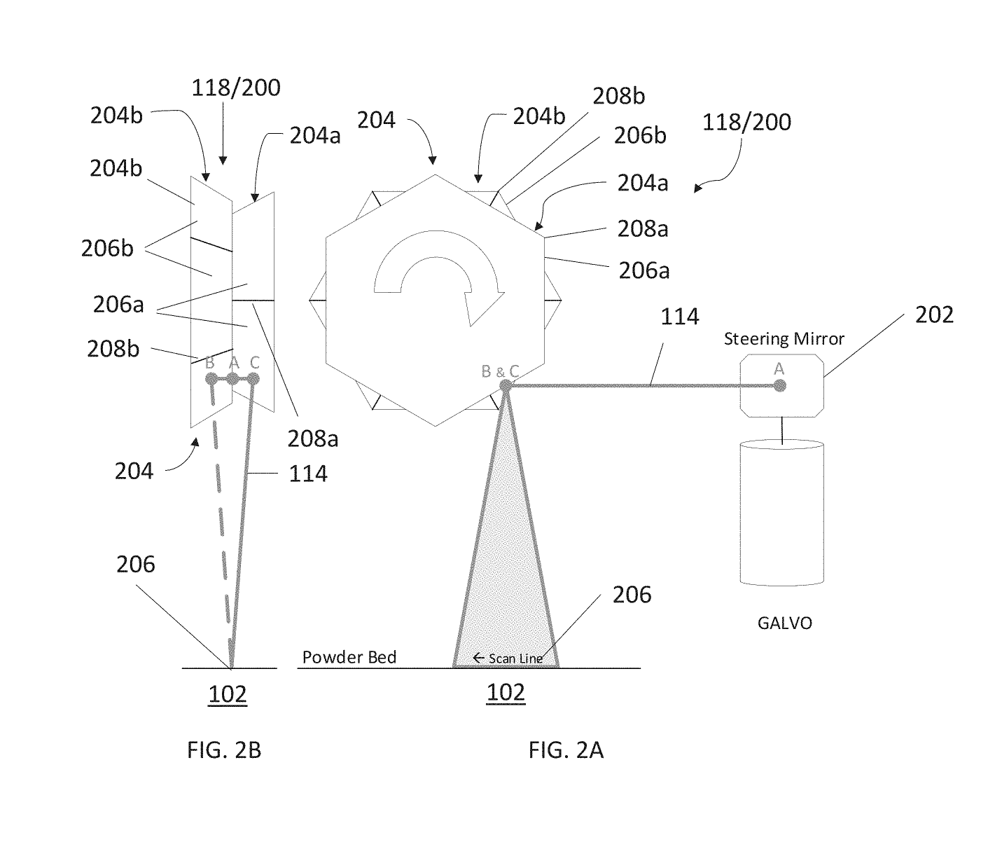

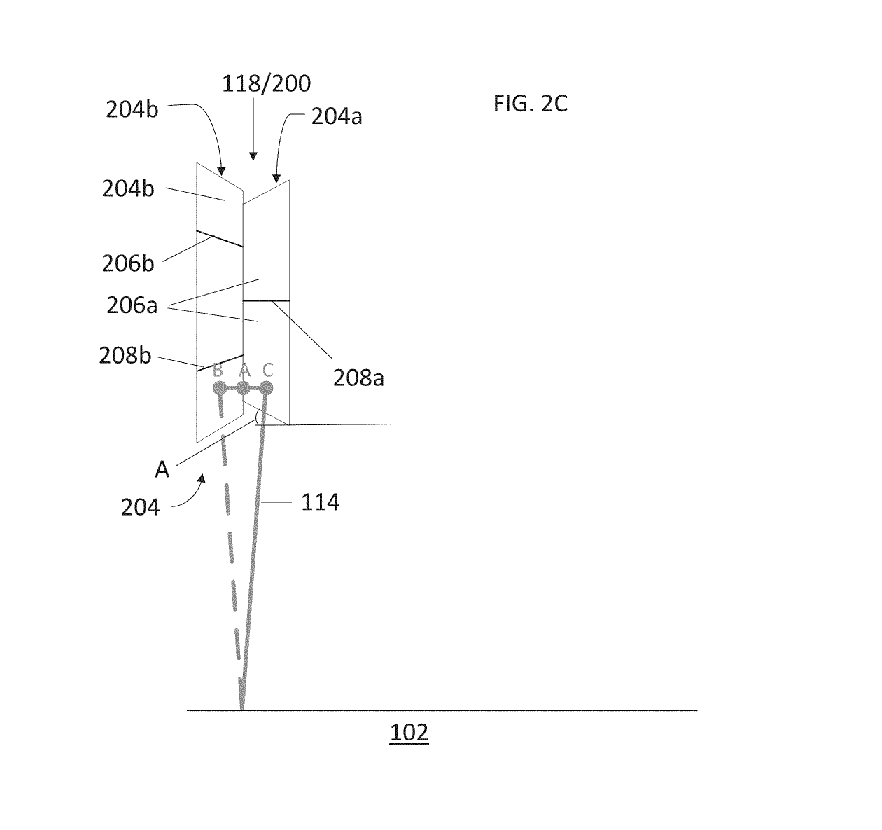

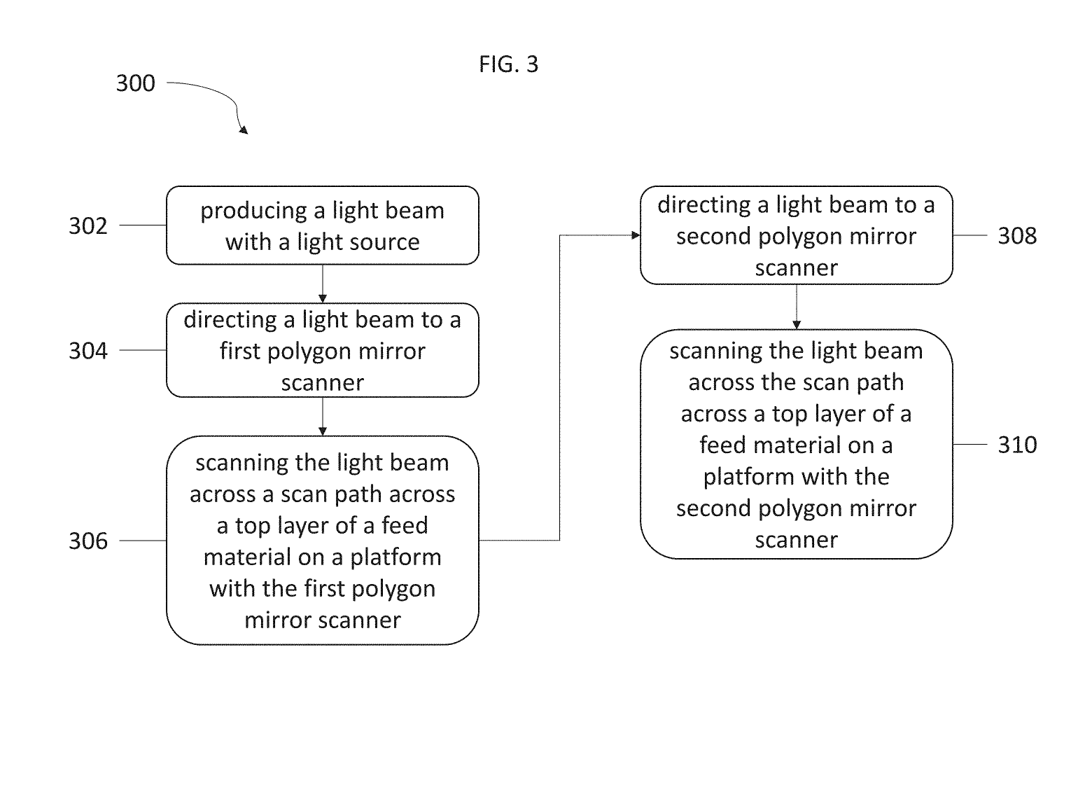

FIG. 2A shows a side view of an example polygon scanner assembly 200 that can be used as the reflector assembly 118. A polygon mirror sub-assembly 204 includes a first polygon mirror scanner 204a configured to receive the light beam 114 from the light source 120 and reflect the light beam towards the platform 102. The polygon mirror sub-assembly 204 also includes a second polygon mirror scanner 204b. The second polygon mirror scanner 204b is also configured to receive the light beam 114 from the light source 120 and reflect the light beam 114 toward the platform 102.

In the illustrated implementation, the first polygon mirror scanner 204a and the second polygon mirror scanner 204b have an equal number of sides. In particular, the first polygon mirror scanner 204a has a plurality of facets 206a with adjacent facets 206a joined at edges 208a. Similarly, the second polygon mirror scanner 204b has a plurality of facets 206b with adjacent facets 206b joined at edges 208b. The first and second polygon mirror scanners 204a, 204b can be the same size, e.g., the facets 206a, 206b can have the same length. Individual facets 206a, 206b can be flat, although slightly convex or concave facets are also possible.

The first and second polygon mirror scanners 204a, 204b can rotate about parallel axes. In particular, the first polygon mirror scan 204a can share a same axis of rotation as the second polygon mirror scanner 204a. In this case, the second polygon mirror 204b can be offset from the first polygon mirror 204a only along the axis of rotation.

The second polygon mirror scanner 204b can be positioned adjacent the first polygon mirror scanner 204b. For example, a distance between the first polygon mirror scanner 204a and second polygon mirror scanner 204b can be less than a length of a facet. In some implementations, the first polygon mirror 204a contacts the second polygon mirror scanner 204b. Although FIG. 2B shows the first polygon mirror scanner 204a and the second polygon mirror scanner 204b abut one another, the polygon mirror sub-assembly 204 can include a gap between the first polygon mirror scanner 204a and the second polygon mirror scanner 204b in some instances. That is, the second polygon mirror scanner 204b can be offset from first polygon mirror 204a scanner along the axis of rotation.

The first polygon mirror scanner 204a and the second polygon mirror scanner 204b can be offset from one another so that edges 208a of the first polygon mirror scanner 204a are positioned at approximate centers of facets 206b of the second polygon mirror scanner 204b as shown in FIG. 2B. Conversely, edges 208b of the second polygon mirror scanner 204b is are positioned at approximate centers of facets 206a of the first polygon mirror scanner 204a.

In some implementations, the first polygon mirror scanner 204a and the second polygon mirror scanner 204b are configured to reflect the light beam 114 towards a same scan path 206. That is, the first polygon mirror scanner 204a and the second polygon mirror scanner 204b have faces oriented to direct the light beam 114 to the same scan path 206. In order to achieve this, the first polygon mirror scanner 204a has a first set of facets 206a oriented such that the face of the facet is inclined along the axis of rotation. As a result, the facet of the first polygon mirror scanner 204a that reflects the light beam 114 is at a first inclination relative to the platform 102 (shown by angle A in FIG. 2C). Similarly, the second polygon mirror scanner 204b has a second set of facets 206b oriented such that the faces of the facet are included along the axis of rotation. As a result, the facet of the second polygon mirror scanner 204b that reflects the light beam 114 is at a different second inclination relative to the platform 102. In instances where the first polygon mirror scanner 204a and the second polygon mirror scanner 204b are configured to reflect the light beam 114 towards a same scan path 206 and the light beam 114 is incident on a facet from a direction substantially perpendicular to the axis of rotation of the mirror scanner, the first inclination can have equal magnitude and opposite direction to the second inclination. In some instances, the scan path 206 is perpendicular to the axis of rotation of the first polygon mirror scanner 204a and second polygon mirror scanner 204b.

In some implementations, the first polygon mirror scanner and the second polygon mirror scanner are configured to rotate in unison with one another, e.g., in the same direction and rate of rotation. In such an instance, the first polygon mirror scanner 204a and the second polygon mirror scanner 204b can have a common axle and a common motor to drive the axle.

In some instances, the first polygon mirror scanner 204a and the second polygon mirror scanner 204b are configured to rotate in in opposite directions to one another. Such an instance can include the first polygon mirror scanner 204a and the second polygon mirror scanner 204b having different axles for rotation. In some instances, different motors can be used to rotate each of the separate axles. In some instances, a single motor can drive an axle for both the first polygon mirror scanner 204a and the second polygon mirror scanner 204b, while a gearbox causes different directions of rotation.

As illustrated, a steering mirror 202 is configured to direct, or “steer” the light beam 114 from the light source 120 alternately to the first polygon mirror scanner 204a and the second polygon mirror scanner 204b. The light source 120, e.g. a laser, directs the light beam 114 to point “A” on the steering mirror 202. The steering mirror 202 can be a single-axis mirror scanner. For example, the steering mirror 202 can include a galvo mirror scanner, or another type of mirror scanner. The steering mirror 202 directs the light beam 114 to either point “B” or point “C” depending on the orientation of the steering mirror 202.

In particular, the steering mirror 202 can be used to direct the light beam 114 back and forth between the polygons mirror scanners 204a, 204b with the light beam being reflected from a facet on one polygon while the other polygon is at a position that the light beam would impinge a portion of the facet that would be “dead time,” and vice versa. As such, the steering mirror 202 causes the light beam 114 to switch from one polygon mirror scanner to another once per facet. Such a set-up allows the light beam, e.g., the laser, to remain on up to nearly 100% of the time. The controller can cause the steering mirror 202 to switch to a different polygon so that only the center 50% of a facet is used. For example, the controller 202 can cause the steering mirror 202 to switch the light beam 114 to a different polygon when the polygon has rotated through about one-half of the angle subtended by the facet. For example, for two octagonal polygons, the steering mirror 202 can cause the light beam to alternate between the polygons every 22.5° of rotation by the polygons. In addition, the controller 202 can cause the steering mirror 202 to switch the light beam to a different polygon when the polygon has rotated past the point where the light beam would impinge an edge 208 by an angle equal to about ¾ of the angle subtended by a facet. Conversely, this causes the light beam to start to impinge a new facet at a point about when the polygon has rotated past the point where the light beam would impinge an edge 208 by an angle equal to about ¼ of the angle subtended by a facet. For example, for two octagonal polygons, the steering mirror 202 can cause the light beam to switch when polygon has rotated to a point about 37.75° past the point where the light beam 114 would impinge the edge. As a result, each light beam would impinge a facet while the facet is rotating between a point 11.25° to a point about 37.75° past the point where the light beam 114 would impinge the edge. Timing of changes of the position of the light beam 114 by the steering mirror 202 can be determined by the controller based on position data from an encoder.

The light source 120 can be deactivated during the short period in which the steering mirror 202 shifts position to change from directing the light beam from B to C, or vice versa. However, because the steering mirror 202 is fast, e.g., is a piezoelectric driven mirror, the light source only need be deactivated for a very short period of time. However, in some implementations, the light source can be left on while the steering mirror shifts position.

Because of the speed of the steering mirror 202, the light source can be active a majority of the time. This will bring the efficiency up from 50% laser use to near 100%. Part fabrication time may be decreased as much as 50%. Because the dead time has been significantly reduced or eliminated between scans, residual heat energy from the previous scan is preserved and can be used to increase the laser speed.

In some implementations, two separate light sources can be used in lieu of the single-axis mirror scanner 202. The light sources can be alternately activated, such that light beams are directed alternately to the two first and second polygon mirror scanners 204a, 204b.

In some implementations, the steering mirror 202 can be used to compensate for variation in the angular orientation of the facets 206a, 206b of the polygon mirror scanners 204a, 204b, either from facet-to-facet, within a facet, or both.

For example, referring to FIGS. 2B and 2C, the angle A can vary from facet to facet of the polygon in a polygon mirror scanner, e.g., simply due to manufacturing tolerances. As a result, without compensation, the successive paths 206 of the light beam 114 resulting from successive facets 206a, 206b would be deflected to different positions along an axis perpendicular to the direction of the paths 206. However, the orientation of the steering mirror 202 can be adjusted from facet to facet to project the light beam 114 onto different positions on the respective facets of a given polygon mirror scanner, such that each facet projects the light beam 114 along the same co-linear path. In particular, by adjusting the position at which the light beam 114 impinges the facet (leftward or rightward in FIG. 2A, or into or out of page in FIG. 2B), the angle of reflection from the facet can be adjusted, thus adjusting the position of the light beam 114 on the feed material.

For example, during a calibration procedure, a position of the scan path 206 on a calibration layer facet can be measured for each facet, with the scanning mirror 202 being set in a default position for each facet. These measurements can be used to generate data that indicating corrected positions for the steering mirror to compensate for the offset of the scan path 206. For example, a look-up table can have an entry for each facet, with each entry indicating an offset angle β for steering mirror 202 relative to the default position.

In operation, a controller can receive a signal from an encoder that drives the polygon mirror. For example, the encoder can generate a pulse N times per rotation, with N being the number of facets. The controller can count pulses to determine which facet is reflecting the light beam, the offset angle from the lookup table for that facet can be determined, and the steering mirror can be set to the offset angle indicated by the entry.

As another example, referring to FIGS. 2B and 2C, at least one facet can be oriented such that the angle A varies across the face of the facet, e.g., again due to manufacturing tolerances. As a result, without compensation, the path 206 of the light beam 114 resulting from scanning by the facet can be canted (at an angle) relative to a desired path, or be non-linear. However, the orientation of the steering mirror 202 can be adjusted as the light beam scans across the facet such to create a linear path along the desired direction. As noted above, by adjusting the position at which the light beam 114 impinges the facet (leftward or rightward in FIG. 2A, or into or out of page in FIG. 2B), the angle of reflection from the facet can be adjusted, thus adjusting the position of the light beam 114 on the feed material. For example, during a calibration procedure, for each facet, the offset of the scan path 206 from a desired path can be measured for multiple positions along the path (similar to the procedure discussed above, the scanning mirror 202 can set in a default position for each facet). These measurements can be used to generate data that indicating corrected positions for the steering mirror to compensate for the variation of the scan path 206 from the desired path. For example, a look-up table can have a plurality of entries for each facet, with each entry indicating an offset angle β for steering mirror 202 relative to the default position. The entries can be tagged with data indicating the rotational orientation of the polygonal mirror scanner at which the offset angle should be applied.

In operation, a controller can receive a signal from an encoder that drives the polygon mirror. The controller can determine a rotation rate of the polygon mirror from the signal from the encoder. Based on the rotation rate and elapsed time, and using a periodic signal from the encoder to counteract drift, the controller can determine the current rotational orientation of the polygonal mirror. The controller can determine which entry from the lookup table should be used for that rotational orientation, and the steering mirror can be set to the offset angle indicated by the entry. This permits the position of the steering mirror to be adjusted even as the light beam scans across a single facet of the polygonal scanning mirror.

FIG. 3 is a flowchart of an example method 300 that can be used with aspects of this disclosure. At 302, a light beam is produced with a light source. At 304, a light beam is directed to a first polygon mirror scanner (but not a second polygon mirror scanner). In some instances, directing a light beam to the first polygon mirror scanner includes reflecting the light beam off of a steering mirror. At 306, the light beam is scanned across a scan path across a top layer of a feed material on a platform with the first polygon mirror scanner. At 308, a light beam is directed to a second polygon mirror scanner (but not the first polygon mirror scanner). In some instances, directing a light beam to the second polygon mirror scanner comprises reflecting the light beam off of the steering mirror, e.g., changing the orientation of the steering mirror. At 310, the light beam is scanned across the scan path across a top layer of a feed material on a platform with the second polygon mirror scanner. In some instances, the first polygon mirror scanner and the second polygon mirror scanner are rotated along a same axis, at a same speed, and in a same direction of rotation. In some instances, the first polygon mirror scanner and the second polygon mirror scanner are rotated along a same axis, at a same speed, and in an opposite direction of rotation.

Controllers and computing devices can implement these operations and other processes and operations described herein. As described above, the controller 108 can include one or more processing devices connected to the various components of the apparatus 100. The controller 108 can coordinate the operation and cause the apparatus 100 to carry out the various functional operations or sequence of steps described above.

The controller 108 and other computing devices part of systems described herein can be implemented in digital electronic circuitry, or in computer software, firmware, or hardware. For example, the controller can include a processor to execute a computer program as stored in a computer program product, e.g., in a non-transitory machine readable storage medium. Such a computer program (also known as a program, software, software application, or code) can be written in any form of programming language, including compiled or interpreted languages, and it can be deployed in any form, including as a standalone program or as a module, component, subroutine, or other unit suitable for use in a computing environment.

The controller 108 and other computing devices part of systems described herein can include non-transitory computer readable medium to store a data object, e.g., a computer aided design (CAD)-compatible file that identifies the pattern in which the feed material should be deposited for each layer. For example, the data object could be an STL-formatted file, a 3D Manufacturing Format (3MF) file, or an Additive Manufacturing File Format (AMF) file. In addition, the data object could be other formats, such as multiple files or a file with multiple layers in tiff, jpeg, or bitmap format. For example, the controller could receive the data object from a remote computer. A processor in the controller 108, e.g., as controlled by firmware or software, can interpret the data object received from the computer to generate the set of signals necessary to control the components of the system 100 to fuse the specified pattern for each layer.

As previously stated, the additive manufacturing system 100 includes a controller 108. The controller 108 is configured to cause the light source 120 to generate a light beam more than 50% of a time scanning of the light beam across the layer of feed material 110, where a continuous line is to be generated across the layer of feed material 110. The controller 108 is configured to turn off the light beam 114 during transition between first polygon mirror scanner 204a and the second polygon mirror scanner 204b. The controller 108 includes a computer-readable storage medium storing instructions executable by a microprocessor within the controller 108. The instructions include the following. The light beam 114 is produced with the light source 120 directing a light beam to a first polygon mirror scanner, and the light beam 114 is scanned across a scan path 206 across a top layer of a feed material 110 on a platform 102 with the first polygon mirror scanner 204a. The light beam 114 is directed to a second polygon mirror scanner 204b, and the light beam 114 is scanned across the scan path 206 across a top layer of a feed material 110 on a platform 102 with the second polygon mirror scanner 204b.

The processing conditions for additive manufacturing of metals and ceramics are significantly different than those for plastics. For example, in general, metals and ceramics require significantly higher processing temperatures. Thus, 3D printing techniques for plastic may not be applicable to metal or ceramic processing and equipment may not be equivalent. However, some techniques described here could be applicable to polymer powders, e.g. nylon, ABS, polyetheretherketone (PEEK), polyetherketoneketone (PEKK) and polystyrene.

While this disclosure contains many specific implementation details, these should not be construed as limitations on the scope of what may be claimed, but rather as descriptions of features specific to particular implementations. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described above should not be understood as requiring such separation in all implementations, and it should be understood that the described program components and systems can generally be integrated together in a single product or packaged into multiple products.

Thus, particular implementations of the subject matter have been described. Other implementations are within the scope of the following claims.
Optionally, some parts of the additive manufacturing system 100, e.g., the build platform 102 and feed material delivery system, can be enclosed by a housing. The housing can, for example, allow a vacuum environment to be maintained in a chamber inside the housing, e.g., pressures at about 1 Torr or below. Alternatively, the interior of the chamber can be a substantially pure gas, e.g., a gas that has been filtered to remove particulates, or the chamber can be vented to atmosphere. Pure gas can constitute inert gases such as argon, nitrogen, xenon, and mixed inert gases.
Aspect of this disclosure can be applicable in other polygon laser applications such as Marking and 3D Scanning.
In another possible configuration, the second polygon may be counter-rotated to achieve a reciprocal scanning pattern instead of a unidirectional pattern.

In some cases, the actions recited in the claims can be performed in a different order and still achieve desirable results. In addition, the processes depicted in the accompanying figures do not necessarily require the particular order shown, or sequential order, to achieve desirable results.

1. An additive manufacturing apparatus comprising:
a platform;
a dispenser configured to deliver a plurality of successive layers of feed material onto the platform;
a light source configured to generate a light beam;
a first polygon mirror scanner to receive the light beam from the light source and reflect the light beam towards the platform; and
a second polygon mirror scanner to receive the light beam from the light source and reflect the light beam towards the platform;
wherein the light source is configured to alternately direct the light beam to the first polygon mirror scanner and the second polygon mirror scanner such that the light beam is directed to the first polygon mirror scanner during a dead time of the second polygon mirror scanner and the light beam is directed to the second polygon mirror scanner during a dead time of the first polygon mirror scanner.

2. The apparatus of claim 1, wherein an axis of rotation of the first polygon mirror scanner is parallel to an axis of rotation of the second polygon mirror scanner.

3. The apparatus of claim 2, wherein the first polygon mirror scanner and the second polygon mirror scanner share a common axis of rotation.

4. The apparatus of claim 3, wherein the first polygon mirror scanner and the second polygon mirror scanner have an equal number of facets.

5. The apparatus of claim 4, wherein facets of the first polygon mirror scanner are angularly offset from facets of the second polygon mirror scanner.

6. The apparatus of claim 5, wherein the first polygon mirror scanner and the second polygon mirror scanner are angularly offset from one another such that an edge of the first polygon mirror scanner is in-line with an approximate center of a face of the second polygon mirror scanner.

7. The apparatus of claim 3, wherein the first polygon mirror scanner has a first plurality of facets with a first inclination relative to the common axis of rotation, and the second polygon mirror scanner has a second plurality of facets with a different second inclination relative to the common axis of rotation.

8. The apparatus of claim 7, wherein the first inclination is equal magnitude and opposite direction to the second inclination.

9. The apparatus of claim 1, wherein the second polygon mirror scanner is adjacent the first polygon mirror scanner.

10. The apparatus of claim 9, wherein the second polygon mirror scanner abuts the first polygon mirror scanner.

11. The apparatus of claim 1, further comprising a steering mirror configured to direct the light beam from the light source alternately to the first polygon mirror scanner and the second polygon mirror scanner.

12. The apparatus of claim 11, wherein the steering mirror comprises a single-axis mirror scanner.

13. The apparatus of claim 1, wherein the first polygon mirror scanner and the second polygon mirror scanner are configured to reflect the light beam towards a same scan path on an outermost layer of feed material.

14. The apparatus of claim 13, wherein the scan path is perpendicular to the axis of rotation of the first polygon mirror scanner and the axis of rotation of the second polygon mirror scanner.

15. The apparatus of claim 1, wherein the first polygon mirror scanner and the second polygon mirror scanner are configured to rotate in unison with one another.

16. The apparatus of claim 15, wherein the first polygon mirror scanner and the second polygon mirror scanner have a common axle and a common motor to drive the axle.

17. The apparatus of claim 1, wherein the first polygon mirror scanner and the second polygon mirror scanner are configured to rotate in opposite directions to one another.

18. The apparatus of claim 1, comprising a controller configured to, where a continuous line is to be generated across the layer of feed material, cause the light source to generate a light beam more for than 50% of a rotational period of the first polygon scanner mirror.

19. The apparatus of claim 1, comprising a controller configured to turn off the light beam during transition between first polygon mirror scanner and the second polygon mirror.

20. An additive manufacturing method comprising:
producing a light beam with a light source;
alternating between
directing the light beam to a first polygon mirror scanner and scanning the light beam across a scan path across a top layer of a feed material on a platform with the first polygon mirror scanner, and
directing a light beam to a second polygon mirror scanner and scanning the light beam across the scan path across a top layer of a feed material on a platform with the second polygon mirror scanner;
wherein the light beam is directed to the first polygon mirror scanner during a dead time of the second polygon mirror scanner and the light beam is directed to the second polygon mirror scanner during a dead time of the first polygon mirror scanner.
